(19) United States
(12) Patent Application Publication
(10) Pub. No.: US 2006/0009106 A1
(43) Pub. Date: Jan. 12, 2006

(54) Wiping sheet

(75) Inventors: Akinori Nishimura, Kako-gun (JP); Mitsuhiro Aota, Akashi-shi (JP)

Correspondence Address: HAMRE, SCHUMANN, MUELLER & LARSON, P.C., P.O. BOX 2902-0902, MINNEAPOLIS, MN, 55402, US

(73) Assignees: DAIWBO CO., LTD., Osaka-shi (JP); DIPRO CO., LTD., Shikokuchuo-shi (JP)

(21) Appl. No.: 11/132,716

(22) Filed: May 19, 2005

(30) Foreign Application Priority Data
May 20, 2004 (JP) P2004-151085
Dec. 17, 2004 (JP) P2004-366294

(51) Int. Cl. B32B 3/00; B32B 5/02; B32B 9/04; B32B 27/30; B32B 23/02; D04H 1/00; D04H 1/46; D04H 1/54

(52) U.S. Cl. 442/404; 442/59; 442/152; 442/153; 442/155; 442/165; 442/334; 442/340; 442/341; 442/342; 442/361; 442/402; 442/408; 442/411

(57) ABSTRACT

A wiping sheet is provided, which presents excellent in handling during wiping, high wiping ability for greasy dirt, and less liquid remains on an object after wiping. A wiping sheet having a fiber structure (such as a woven fabric, a knitted fabric and a nonwoven) is obtained, which includes an ultrafine fiber layer containing ultrafine fibers having a fineness of at most 0.9 dtex which result from at least two types of ultrafine fiber-generating conjugate fibers, at least one conjugate fiber giving ultrafine fibers containing a modified vinyl alcohol resin, and the other conjugate fibers giving ultrafine fibers containing another resin(s). The ultrafine fibers can be obtained by a first splittable conjugate fiber including a component containing the modified vinyl alcohol resin and a second splittable conjugate fiber composed of components of other resins. In the ultrafine fiber layer, the fibers are preferably bonded by thermoadhesive resin-containing ultrafine fibers.

### CROSS-REFERENCE TO RELATED APPLICATIONS

The present application claims a priority under 35 U.S.C. §119 to Japanese Patent Application Nos. 2004-151085 filed on May 20, 2004, entitled “CLEANING NONWOVEN” and 2004-366294 filed on Dec. 17, 2004 entitled “LAMINATED SHEET AND PRODUCTION METHOD OF THE SAME.” The contents of those applications are incorporated herein by the reference thereto in their entirety.

### TECHNICAL FIELD

The present invention is related to a wiping sheet which is excellent in handling property during a wiping operation, has high wiping ability for greasy dirt and shows a little liquid remains on an object after an wiping operation.

### BACKGROUND OF THE INVENTION

A nonwoven wherein splittable conjugate fibers are employed has long been used as a wiper which shows high wiping ability. For example, Japanese Patent Kokai (Laid-Open) Publication No. 10-280262(A) discloses a nonwoven which is produced by subjecting a nonwoven web obtained by blending splittable bicomponent conjugate staple fibers (30 to 70% by weight) and water-absorptive staple fibers (70% to 30% by weight) to a high-pressure liquid stream treatment so that the conjugate fibers split into ultrafine fibers of a component having a low melting-point and ultrafine fibers of a component having a high melting-point and the fibers are entangled three-dimensionally, and then carrying out a heat treatment at a temperature at which the low melting point component melts and softens so as to thermally bond the fibers, and further suggests using the nonwoven as a wiper. Japanese Patent Kokai (Laid-Open) Publication No. 11-217757(A) discloses a nonwoven which is obtained by forming a nonwoven web by blending splittable bicomponent conjugate staple fibers (30% to 70% by weight) whose components are selected from a polyester, a polyamide, and a polyethylene with water absorptive staple fibers (70% to 30% by weight) and subjecting the web to a high-pressure liquid stream treatment so that the conjugate fibers are split at a splitting rate of not lower than 85% into split short fibers and the constituent fibers are entangled three-dimensionally, and suggest using this nonwoven as a wiper. Further, Japanese Patent Kokai (Laid-Open) Publication No. 11-2470759(A) discloses a nonwoven which is produced by obtaining a nonwoven web by blending splittable bicomponent conjugate staple fibers (90% to 60% by weight) and thermoadhesive staple fibers (10% to 40% by weight) and subjecting the nonwoven web to a high-pressure liquid stream treatment so that the conjugate fibers split into ultrafine fibers of a low melting-point polymer and ultrafine fibers of a high melting point polymer and the constituent fibers are entangled three dimensionally and then thermally treating the nonwoven web at a temperature at which the thermoadhesive fibers melts and softens so as to bond the fibers, and suggest using the nonwoven as a wiper. Furthermore, Japanese Patent Kokai (Laid-Open) Publication No. 2001-190469(A) discloses a composite nonwoven wherein an ultrafine fiber layer that is composed of fibers having a mean fiber length of 30 mm to 100 mm is disposed on at least one surface of a water-absorptive fiber layer and these layers are integrated by three-dimensional entanglement, the water-absorptive layer containing water-absorptive fibers having a mean fiber length shorter than 20 mm in an amount of more than 50% by weight and the ultrafine fiber layer containing splittable conjugate fibers in an amount of 50% by weight. This document suggests using this composite nonwoven as a cleaning wiper.

A wet wiper is also used, wherein a nonwoven is impregnated with a wetting agent such as a cleaning agent in order to improve wiping ability. For example, Japanese Patent Kokai (Laid-Open) Publication No. 2001-073267(A) discloses a wet wiper which are constituted mainly of thermoplastic polyvinyl alcohol fibers containing a thermoplastic polyvinyl alcohol of 100 parts by weight and an alkali metal ion of 0.0003 to 1 parts by weight in terms of sodium ion, wherein the polyvinyl alcohol has a viscosity average polymerization degree of 200 to 600, a saponification degree of 90% to 99.99% by mol, a mole fraction of central hydroxy group of a three-hydroxy group chain in a vinyl alcohol unit expressed by a triad method of 70% to 99.9% by mole and a melting point of 160° C. to 230° C.

Japanese Patent Kokai (Laid-Open) Publication No. 54-82841(A) discloses a nonwoven which is not a cleaning nonwoven, but has a construction similar to that of the cleaning nonwoven disclosed in Japanese Patent Kokai (Laid-Open) Publication No. 2001-190469(A). This document discloses that a nonwoven whose draping and physical property are excellent is obtained by stacking a staple fiber web (B) on a substrate (A) and applying water streams to integrate them, wherein the substrate (A) is a nonwoven with no apertures or opens which is formed of staple fibers which are bonded by partial and thermal compression bonding and has many free ends. Further, this document discloses that a nonwoven made only by regenerated cellulose fibers is used as the substrate (A).

### SUMMARY OF THE INVENTION

Any of the nonwovens as disclosed in the above documents, however, has the following problems in the case where it is used as a wiping sheet. Firstly, there is a problem that liquid tends to remain on a surface of an object after the liquid is wiped off from the object using the nonwoven or after the object is wiped with the nonwoven impregnated with the wetting agent, that is, “liquid remains” tends to occur. When the liquid which remains on the surface of the object is dried, it becomes into streaks or spots of grime which remain on the surface. Secondary, any of the nonwovens shows insufficient wiping ability. Thirdly, any of the nonwovens is not necessarily suitable for being used in a circumstance wherein lint falling is undesired, such as a clean room.

Japanese Patent Kokai (Laid-Open) Publication No. 2001-190469(A) aims at reducing an amount of liquid remained on the surface of the object after wiping, and suggests employing a laminated structure so as to reduce exposure of the water-absorptive fibers on a surface of the ultrafine fiber layer in order to achieve the aim. The nonwoven disclosed in Japanese Patent Kokai (Laid-Open) Publication No. 2001-190469(A), however, leaves a room for improvement in the liquid remains in the case where it is used as a wiper for an object, for example, a glass surface and a display, which requires less liquid remains. Further, Japanese Patent Kokai (Laid-Open) Publication No. 2001-190469(A) does not mention the nonwoven structure which is suitable for improving the wiping ability for greasy dirt. Furthermore, the nonwoven disclosed in Japanese Kokai (Laid-Open) Publication No. 2001-190469(A) is not necessarily suitable for being used in the clean room since lint tends to generate due to the short average fiber length of the water-absorptive fibers.

The nonwoven disclosed in Japanese Patent Kokai (Laid-Open) Publication No. 54-82841(A) is not assumed to be used as a wiper and the document does not teach a nonwoven construction which is suitable for the wiper.

The present invention is made in light of the above problems and the object of the present invention is to obtain a wiping sheet which is excellent in handling property during a wiping operation, has high wiping ability for greasy dirt and shows a little liquid remains after liquid is wiped off from an object or after an object is wiped using the wiping sheet impregnated with a wetting agent.

The inventors considered and studied the liquid remains after wiping. As a result, the inventors concluded that the liquid remains is increased when the nonwoven has excess water absorptiveness. Further, the inventors concluded that mere employment of the splittable conjugate fibers for constituent fibers of the nonwoven can improve the wiping ability, but cannot effectively reduce the liquid remains. For this reason, a wiping sheet is constituted using ultrafine fibers made of a modified vinyl alcohol resin which is hydrophilic, but does not retain the liquid actively. As a result, the inventor has found that the wiping sheet has an excellent wiping ability and shows a little liquid remains, and achieves the present invention.

The present invention provides a wiping sheet including a fibrous structure which has an ultrafine fiber layer including ultrafine fibers which are obtained from at least two types of ultrafine fiber-generating conjugate fibers and have a fineness of not greater than 0.9 dtex, wherein the ultrafine fibers that are obtained from at least one type of the ultrafine fiber-generating conjugate fiber comprise a modified vinyl alcohol resin, and one or more types of the ultrafine fibers that are obtained from the other ultrafine fiber-generating conjugate fibers comprise another resin(s).

This wiping sheet shows a little liquid remains on an object after the object (including things and a person) is wiped, and shows high wiping ability for greasy dirt. This wiping sheet also shows small fiber fuzzing and lint (or fiber falling) during a wiping operation since the ultrafine fibers containing resin(s) other than the modified vinyl alcohol resin serves as a skeleton for the ultrafine fiber layer. Further, the wiping sheet of the present invention is characterized in that the ultrafine fibers containing the modified vinyl alcohol resin and the ultrafine fibers containing the another resin(s) are obtained from different ultrafine fiber-generating conjugate fibers. Because of this characteristic, the ultrafine fiber layer has a construction wherein two or more types of ultrafine fibers are laid more randomly in the wiping sheet of the present invention. In other words, the ultrafine fibers containing resin(s) other than the modified vinyl alcohol resin exit in various directions between the fibers containing the modified vinyl alcohol resin to serve well as the skeleton, whereby the dust emission from the wiping sheet is reduced. Therefore, the wiping sheet of the present invention may be advantageously used as a wiping sheet for things and a wiping sheet for a person to remove the dirt or greasy dirt adhered to the things such as OA equipment (for example, a display), glasses, cars, kitchen, and shoes, and person, or may be used as a wiping sheet in the clean room.

Herein, the term “fibrous structure” is used in the meaning that it widely covers sheets made of fibers. Specifically, the fibrous structure refers to a woven fabric, a knitted fabric, a nonwoven (including a wetlaid nonwoven) or any combination thereof. It should be noted that, in this specification, the meaning of the term “wiping” is broadly interpreted and the “wiping sheets” include a sheet for removing materials other than dirt (such as ink used for drawing letters or paintings which have been displayed on a glass surface for a predetermined period, and cosmetic material on a face) from an object and a sheet for spreading liquid or paste on an object (including humans), in addition to a sheet for wiping dirt.

The ultrafine fiber-generating conjugate fiber is a conjugate fiber composed of two or more components which generates or gives ultrafine fibers by physical or chemical action and such a conjugate fiber itself is conventionally used. The ultrafine fiber may be obtained by eluting a sheath component of a sea-island conjugate fiber, or may be obtained by splitting a splittable conjugate fiber composed of a plurality of components into respective components. The conjugate fibers may be formed into a spun yarn or a filament yarn which is then woven or knitted followed by being subjected to a treatment for forming ultrafine fibers. In that case, a woven fabric or a knitted fabric itself becomes a ultrafine fiber layer. Alternatively, a fiber web may be formed from the conjugate fibers and then may be subjected to a treatment for entangling the fibers and a treatment for forming the ultrafine fibers so that a nonwoven is obtained. The fiber web containing the conjugate fibers may be subjected to the entangling treatment of the ultrafine fiber-forming treatment after it is laminated on a woven fabric or a knitted fabric. In that case, the wiping sheet of the present invention becomes a composite sheet composed of the nonwoven and the woven fabric or the knitted fabric.

The wiping sheet of the present invention may be preferably a sheet wherein the ultrafine fibers are formed by splitting the splittable fibers composed of a plurality of components into the respective components and the constituent fibers of the ultrafine fiber layer are entangled by a hydroentangling treatment. Such an ultrafine fiber layer shows good wiping ability and a little lint since it gives a thick and dense wiping face due to a tight hydroentanglement of the ultrafine fibers. Further, such a ultrafine fiber layer is particularly suitable for constituting a disposable wiping sheet since the production of the ultrafine fiber layer is relatively easy.

The splittable conjugate fibers which give the ultrafine fibers may be preferably a first splittable conjugate fiber that is composed of a component containing the modified vinyl alcohol resin and at least one another resin component(s), and a second splittable conjugate fibers composed of two resin components made of resins other than the modified vinyl alcohol resin. By using these two types of splittable conjugate fibers, many types of (for example, four types of) ultrafine fibers exist in the ultrafine fiber layer. Such an ultrafine fiber layer can gives a desired performance and a desired physical property to the wiping sheet by properly selecting the ultrafine fibers containing the resins other than the modified vinyl alcohol.

In the wiping sheet of the present invention, it is preferable that the constituent fibers are bonded with a thermoadhesive resin in the ultrafine fiber layer. Specifically, the ultrafine fiber layer is preferably made of the ultrafine fibers containing the modified alcohol resin, ultrafine fibers containing the thermoadhesive resin, and ultrafine fibers containing another resin(s) (resin(s) other than the modified vinyl alcohol resin and the thermoadhesive resin), wherein the constituent fibers are bonded with the thermoadhesive resin. Specifically, the thermoadhesive resin is a resin whose melting point is lower by at least 10° C. than that of any of other resins which make the fibers contained in the ultrafine fiber layer. The wiping sheet including such an ultrafine fiber layer presents more excellent properties in wiping ability, liquid remains and fiber fuzzing.

In the case where the ultrafine fiber layer contains the ultrafine fibers obtained by splitting the two types of splittable conjugate fibers, the second splittable conjugate fiber is preferably composed of a component containing the thermoadhesive resin whose melting point is lower by at least 10° C. than that of resins that constitute the first splittable conjugate fiber, and the constituent fibers of the ultrafine fiber layer are thermally bonded with the thermoadhesive resin deriving from the second splittable conjugate fiber.

### BRIEF DESCRIPTION OF THE DRAWINGS

FIG. 1 shows cross-sectional views of examples of splittable conjugate fibers used in the present invention.

### DETAILED DESCRIPTION OF THE PREFERRED EMBODIMENTS

### Embodiment 1

A wiping sheet of a nonwoven which is composed of a single ultrafine fiber layer is described as Embodiment 1. In the wiping sheet of this embodiment, ultrafine fibers exist in surfaces and inside of the sheet.

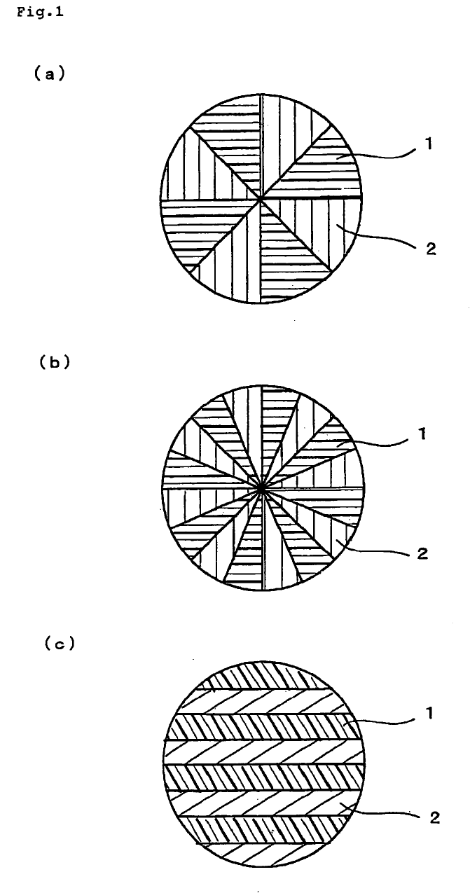

In this embodiment, the ultrafine fiber layer contains the ultrafine fibers whose fineness is not greater than 0.9 dtex, which are formed by splitting the first splittable fibers and the second splittable fibers. The splittable fiber is composed of a plurality of components and has a cross-sectional structure wherein at least one component is divided into two or more segments and at least a portion of each component is exposed on a surface of the fiber and the exposed portion extends continuously in the longitudinal direction of the fiber. Examples of the fiber cross-sectional structure of the splittable conjugate fibers composed of two resin components are shown in FIG. 1(a) to (c). The splittable conjugate fibers of these structures give ultrafine fibers having a modified cross-section such as a wedge shape or a trapezoidal shape by split. It is preferable that fibers of these shapes exist in the wiping sheet since such fibers improve wiping ability. In FIG. 1, although only the splittable conjugate fibers composed of two components are shown, the splittable conjugate fibers may be composed of three components.

The ultrafine fibers obtained by splitting the first and the second splittable conjugate fibers have a fineness of 0.9 dtex or less. The lower limit of the fineness may be preferably 0.05 dtex and the upper limit may be preferably 0.5 dtex. If the fineness of the ultrafine fiber is greater than 0.9 dtex, more liquid remains may be observed on an object.

Next, the first splittable conjugate fiber is described. The first splittable conjugate fiber is composed of a component containing the modified vinyl alcohol resin, and at least one another resin component. The first splittable conjugate fiber is split into respective components to give ultrafine fibers containing the modified vinyl alcohol resin, whose fineness is 0.9 dtex or less (hereinafter this ultrafine fiber is referred to as an “ultrafine fiber “VA””) and ultrafine fibers made of the another resin(s) (hereinafter this ultrafine fiber is referred to as an “ultrafine fiber “A””). The first splittable fiber makes it possible not only to obtain the ultrafine fibers “VA” easily, but also to adjust the content of the ultrafine fibers “VA” easily. Further, the first splittable fiber can realize the development of the ultrafine fibers “VA” and the ultrafine fibers “A” at the same time, which allows desired wiping ability to be easily obtained by selecting the kinds of the ultrafine fibers “A.” Furthermore, the ultrafine fibers “A” reinforce the ultrafine fibers “VA” whose strength is low, and server as a skeleton for the ultrafine fiber layer, whereby the strength of the entire wiping sheet is ensured and the lint is reduced.

The ultrafine fibers “VA” is relatively wetted to liquid such as water. Further, the fiber layer wherein the ultrafine fibers are entangled shows high water absorptivity by capillary action. Therefore, the wiping sheet of this embodiment can absorb the liquid into inside due to high wettability of the ultrafine fibers “VA” and the capillary action in the ultrafine fiber layer. Further, the ultrafine fiber “VA” is excellent in absorptivity for oil and grease, the entangled ultrafine fibers “VA” can effectively retain the oil and grease in the surface and the inside of the nonwoven. Therefore, the wiping sheet including this ultrafine fibers “VA” is excellent in wiping ability for greasy dirt.

The modified vinyl alcohol resin is a copolymer of vinyl alcohol and another monomer. The content of vinyl alcohol in the modified vinyl alcohol resin is preferably in a range of 50 mol % to 70 mol %. The content of vinyl alcohol is more preferably in a range of 55 mol % to 65 mol %. If the content of vinyl alcohol is less than 50 mol %, the wettablity may be decreased. If the content of vinyl alcohol is greater than 70 mol %, the wettablity may be increased, which causes more liquid remains on the surface of the object. Another monomer may be an α-olefin such as ethylene, propylene, 1-buten, isoprene, and 1-hexen. The modified vinyl alcohol resin is preferably ethylene-vinyl alcohol copolymer (which is referred to as “EVOH”) whose ethylene content is in a range of 30 mol % to 50 mol %. EVOH is not wetted by liquid such as water unnecessarily, and represents proper wettability, whereby the wiping sheet composed of the ultrafine fiber layer containing EVOH shows an excellent water absorptivity. Further, EVOH is excellent in absorption of oil and grease, and therefore the wiping sheet composed of the ultrafine fiber layer containing EVOH well retains the greasy dirt. The ethylene content is more preferably in a range of 35 mol % to 45 mol %.

The modified vinyl alcohol resin alone or in a form of a mixture with another resin(s) forms one component of the first splittable conjugate fiber. In the case where the mixture of the modified vinyl alcohol resin and another resin(s) is employed, the ratio of the modified vinyl alcohol resin is preferably at least 50% by mass. If the ratio of the modified vinyl alcohol resin is less than 50% by mass, the grease absorptivity of the ultrafine fibers resulting from the splittable conjugate fiber may be insufficient. The another resin to be mixed with the modified alcohol resin is, for example, polyethylene, ethylene-acrylate copolymer, ethylene-methyl acrylate copolymer, polyvinyl alcohol, ionomer, and a resin used as a wetting agent. It is preferable that the modified vinyl alcohol resin alone constitutes the splittable conjugate fiber (without being mixed with another resin(s)), together with the another resin component.

Next, the another resin component “A” which constitutes the first splittable conjugate fiber is described. The another resin component “A” preferably contains one or more resins selected from a polyester resin such as polyethylene terephthalate and polybutylene terephthalate, a polyamide resin such as nylon 6 and nylon 66, and a polyolefin resin such as polypropylene, and more preferably the polyolefin resin. Therefore, in the case where the first splittable conjugate fiber is composed of a first component and a second component as shown in FIG. 1, the first component preferably contains the modified vinyl alcohol resin and the second component preferably contains the polyolefin resin. The combination of the resin component containing the modified vinyl alcohol resin and the resin component containing the polyolefin is easily split by hydroentangling treatment to give the ultrafine fibers containing the modified vinyl alcohol resin. Further, since the conjugate fiber composed of the resin component containing the modified vinyl alcohol resin and the resin component containing the polyolefin resin gives the ultrafine fibers containing the modified vinyl alcohol which presents appropriate wettability and the ultrafine fibers containing the polyolefin which shows hydrophobicity, the liquid (for example, water) wettability of the surface of the ultrafine fiber layer can be adjusted by changing the ratios of both components. The hydrophobic polyolefin-containing ultrafine fibers increase the slipperiness of the wiping sheet, and thereby the slipperiness on the surface of the object can be adjusted by adjusting the ratio of the resin component “A.” The polyolefin resins include, for example, polyethylene, polypropylene, polybuten-1, polymethylpentene, and a copolymer thereof (such as ethylene-propylene). These resins may be used alone or in combination. The use of the polypropylene resin is particularly preferred since the polypropylene resin is excellent in handling during fiber making.

The polyolefin resin alone or blended with another resin(s) forms one component of the first splittable conjugate fiber. When the blend of the polyolefin resin and another resin(s) is used, the ratio of the polyolefin resin is preferably at least 50% by mass. If the ratio of the polyolefin resin is less than 50% by mass, the splittability of the first splittable conjugate fiber may be decreased and the hydrophobicity of the polyolefin-containing ultrafine fibers may be insufficient. The another resin(s) mixed with the polyolefin resin may be, for example, ionomer. It is preferable that the polyolefin resin alone constitutes the splittable conjugate fiber (that is, without mixing with the another resin(s)), together with the resin component containing the modified vinyl alcohol resin.

The volume ratio of the component containing the modified vinyl alcohol resin to the another resin component (the modified vinyl alcohol-containing resin/the another resin) is preferably in a range of 9/1 to 1/9. A more preferable volume ratio is in a range of 6/4 to 4/6. If the ratio of the component containing the modified vinyl alcohol resin to the another component is below 1/9 in the first splittable conjugate fiber, the portion of the modified vinyl alcohol-containing ultrafine fibers is small in the ultrafine fiber layer, and therefore the liquid remains on the object tend to be increased. If the volume ratio is above 9/1, the portion of the modified vinyl alcohol-containing ultrafine fibers is large, and therefore the hydrophilicity of the wiping sheet is too high and the productivity of such a splittable conjugate fiber may be low.

The fineness of the first splittable conjugate fiber may be selected depending on the finenesses to be obtained, of the ultrafine fiber “VA” and the ultrafine fiber “A.” For example, the fineness of the conjugate fiber is preferably in a range of 0.5 dtex to 5 dtex. More preferable fineness of the first splittable conjugate fiber is in a range of 1 dtex to 4.4 dtex. If the fineness of the first splittable conjugate fiber is less than 0.5 dtex, the productivity of the fiber may be decreased. When the fineness of the first splittable conjugate fiber is greater than 5 dtex, the segment number should be increased in order to obtain the ultrafine fibers “VA”, which decreases the splittability. Further, when the conjugate fiber does not split sufficiently, fibers of a large fineness may remain, which may cause lowering of wiping ability and increase in liquid remains. The segment number of the first splittable conjugate fiber may be preferably in a range of 4 to 32 from the view point of productivity.

Next, the second splittable conjugate fiber is described. The second splittable conjugate fiber is employed in order to confer desired property and wiping ability to the wiping sheet. If an ultrafine fiber layer contains only the ultrafine fibers obtained from the first splittable conjugate fibers in a nonwoven which contains only the ultrafine fiber layer, the strength of the wiping sheet may be low and the dust emission tends to occur due to the lint because the fiber strength of the ultrafine fiber “VA” is low. For avoiding such inconvenience, the second splittable conjugate fibers are employed and the ultrafine fibers obtained from conjugate fibers are forced to be entangled with the ultrafine fibers resulting from the first splittable conjugate fibers and to serve as a skeleton for the ultrafine fiber layer together with the ultrafine fibers “A” so as to reinforce the ultrafine fiber layer.

The second splittable conjugate fiber is constituted using two or more resins selected from a polyester resin such as polyethylene terephthalate and polybutylene terephthalate, a polyamide resin such as nylon 6 and nylon 66, and a polyolefin resin such as polyethylene, polypropylene, polybutene-1, and polymethylpentene, so that the cross-sectional structure as shown in FIGS. 1 to 3 is obtained.

The second splittable conjugate fiber is preferably composed of a component containing a thermoadhesive resin and at least one another resin component (B) and gives, by split, thermoadhesive ultrafine fibers and ultrafine fibers made of the another resin component (hereinafter this ultrafine fiber is referred to “ultrafine fiber “B””). The second splittable conjugate fiber makes it possible not only to easily obtain the thermoadhesive ultrafine fibers, but also to easily adjust the content of the thermoadhesive ultrafine fibers. Further, the ultrafine fibers “B” made of the another resin can be obtained together with the thermoadhesive ultrafine fibers from the second splittable conjugate fiber, and the physical property and/or the feeling of the wiping sheet can be adjusted by properly selecting the another resin. Furthermore, the ultrafine fibers “B” act as the skeleton for the ultrafine fiber layer similarly to the ultrafine fibers “A”, and reinforce the strength of the entire wiping sheet.

The thermoadhesive ultrafine fibers are mixed and entangled with other fibers to exist on the surfaces and the inside of the ultrafine fiber layer. The thermoadhesive ultrafine fibers have a small fineness and therefore bond the constituent fibers while maintaining many intersecting points of the thermoadhesive fibers and the other fibers and micro voids. By bonding the constituent fibers in the ultrafine fiber layer with the thermoadhesive ultrafine fibers, the slipperiness of the wiping sheet is improved, and thereby the dirt can be removed even if the wiping sheet is not strongly rubbed against on the object, and the lint during a wiping operation and the liquid remains can be reduced. The constituent fibers are preferably bonded only the thermoadhesive resin deriving from the second splittable conjugate fibers (that is, thermoadhesive fibers of a large fineness are not mixed in the ultrafine fiber layer). It is thereby possible to achieve the effect of the present invention, that is, the prevention of the lint, the improvement in wiping ability, and the reduction in the liquid remains. Herein, the “thermoadhesive resin deriving from the second splittable conjugate fibers” includes the thermoadhesive resin contained in the ultrafine fibers obtained by split of the second splittable conjugate fibers and the thermoadhesive resin which constitutes one component of the unsplit second splittable conjugate fiber. As described below, the second splittable conjugated fibers are not necessarily split completely. In that case, a part of the unsplit second splittable conjugate fibers may soften and melt to bond the constituent fibers thermally. It should be noted that such thermal adhesion is permitted in the wiping sheet of the present invention.

As the thermoadhesive resin, a resin is used, whose melting point is lower by at least 10° C. than that of any of the resins which constitute the first splittable conjugate fiber. The thermoadhesive resin is preferably a resin whose melting point is lower by at least 15° C. than that of any of the resins which constitute the first splittable conjugate fiber. The thermoadhesive resin is one or more resins selected from, for example, a polyolefin resin such as a polyethlene resin, a propylene copolymeric resin, a polybutene-1 resin, an ethylene-vinyl acetate copolymer resin, an ethylene-acrylate resin and an ethylene-methyl acrylate resin; an aliphatic polyester resin, and a copolymeric polyester resin. These thermoadhesive resins may be optionally mixed with a resin having a high melting point so as to constitute one component of the second splittable conjugate fiber. In that case, the proportion of the thermoadhesive rein in the ultrafine fiber layer is preferably at least 5% by mass and more preferably at least 10% by mass. If the proportion of thermoadhesive resin in the ultrafine fiber layer is less than 5% by mass, the thermoadhesive ultrafine fibers may not bond the constituent fibers sufficiently. The thermoadhesive resin is preferably used without being mixed with another high melting-point resin.

The another resin component “B” constituting the ultrafine fiber “B” is preferably selected from resins whose melting point is higher by at least 10° C., and more preferably at least 15° C., than that of the thermoadhesive resin. As the another resin, a polyester resin such as polyethylene terephthalate and polybutylene terephthalate, a polyamide resin such as nylon 6 and nylon 66, and a polyolefin resin such as polypropylene, and polymethylpentene are exemplified. When the another resin is a mixture of two or more resins, the resins are preferably selected so that the melting point (a temperature at the peak in a fusion curve obtained by DSC) of the resin mixture is higher by at least 10° C. than that of the thermoadhesive resin. The another resin “B” is preferably at least one resin selected from the polyester resin and/or the polyolefin resin. By using the second splittable conjugate fiber whose one component is the polyester resin and/or the polyolefin resin, a mixture of the ultrafine fibers “VA” which represent appropriate wettability and the polyester ultrafine fibers and/or the polyolefin fibers which represent hydrophobicity is obtained in the ultrafine fiber layer. The wettability of the wiping sheet with the liquid (such as water) and the slipperiness of the wiping sheet on the surface of the object can be thereby adjusted.

The second splittable conjugate fiber is preferably a fiber composed of a component containing a polyethylene resin as the thermoadhesive component and a component containing a resin selected from a polyolefin resin and a polyester resin whose melting point is higher by at least 15° C. than that of the polyethylene resin. Specifically, the second splittable conjugate fiber is preferably composed of a combination of the polyethylene resin/the polyethylene terephthalate resin or a combination of the polyethylene resin/the polypropylene resin.

Even if one component of the second splittable conjugate fiber contains the thermoadhesive resin, the thermoadhesive resin is not necessarily required to thermally bond the constituent fibers in the ultrafine fiber layer. In that case, since the thermoadhesive ultrafine fibers generally confers soft feel to a nonwoven, the wiping sheet has a good feel. Further, the wiping sheet has a softness, whereby it easily follows the surface of the object which has fine recesses and protrusions. Therefore, when such a wiping sheet is used against a person, the sheet follows well the three-dimensional skin surface and removes dirt or cosmetic material that is to be wiped off, or applies liquid to the skin well. Further, such a wiping sheet is advantageous in that it less irritates the skin.

The fineness of the second splittable conjugate fiber may be selected depending on the finenesses to be obtained, of the thermoadhesive ultrafine fiber and the ultrafine fiber “B.” For example, the fineness of the conjugate fiber is preferably in a range of 0.5 dtex to 5 dtex. More preferable fineness of the first splittable conjugate fiber is in a range of 1 dtex to 4.4 dtex. If the fineness of the second splittable conjugate fiber is less than 0.5 dtex, the productivity of the fiber may be decreased. If the fineness of the second splittable conjugate fiber is greater than 5 dtex, the segment number should be increased in order to obtain the ultrafine fibers, which decreases the splittability. Further, when the conjugate fiber does not split sufficiently, fibers of a large fineness may remain, which may cause lowering of wiping ability and increase in liquid remains. The segment number of the second splittable conjugate fiber may be preferably in a range of 4 to 32 from the view point of productivity.

Next, a combination of the first splittable conjugate fiber and the second splittable conjugate fiber is described. Both conjugate fibers are preferably combined so that the splitting rate (or the splittability) of the first splittable conjugate fiber is higher than that of the second splittable conjugate fiber. The ultrafine fibers “VA” obtained by highly splitting the first splittable conjugate fibers improve the wiping ability and the liquid remains of the wiping sheet because of moderate wettability and capillary action of the fibers, but the rigidity of the sheet may be somewhat small. For this reason, it is preferable that some of the second splittable conjugate fibers are remained unsplit in the ultrafine fiber layer so that the unsplit second conjugate fibers function as the skeleton to improve the handling ability of the wiping sheet and prevent the lint. Further, the wiping sheet containing the unsplit second splittable conjugate fibers easily follow the surface to be wiped and has an advantage of a high dimensional stability. The splitting rate can be adjusted by the combination of resin components constituting the first and the second splittable conjugate fibers and the cross-sectional structure of the fibers.

The splitting rates of the first and the second splittable conjugate fibers can be observed by enlarging the section of the nonwoven with an electronic microscope and watching the split degrees of both fibers, and thereby which is higher can be determined. Alternatively, this can be determined by measuring the splitting rate of each of the first and the second splittable conjugate fibers according to a method as described below.

The splitting rate of the second splittable conjugate fiber is preferably in a range of 20% to 80%. More preferable splitting rate is 70% or less. If the splitting rate of the second splittable conjugate fiber is less than 20%, the ratio of the unsplit fibers becomes large, which may cause lowering of wiping ability and increase in liquid remains. When the splitting rate is over 80%, the rigidity of the nonwoven may be reduced to lower the handling ability, or the fibers are liable to fall.

The splitting rate of the first splittable conjugate fiber is preferably at least 70%. More preferable splitting rate is at least 80%. If the splitting rate of the first conjugate fiber is less than 70%, the wiping ability may be reduced and the liquid remains may be increased. The respective splitting degrees of the first and second splittable conjugate fibers are determined according to the following procedures.

[Splitting Rate]

(1) Preparation of a Nonwoven for Determining a Splitting Rate

In order to relatively compare the splittability of the first and the second splittable conjugate fibers, a nonwoven is prepared under the same conditions and the splitting rate is determined.

Firstly, a parallel carded web of 40 g/m² is made of 100% by mass of the first splittable conjugate fiber or the second splittable conjugate fiber. Next, the web is placed on a conveyer net that is an 80-mesh plain weave whose warp filament size is 0.17 mm and weft filament size is 0.2 mm, and the web is moved by the conveyer net at a speed of 4 m/min, and the both surfaces of the web are subjected to hydroentangling treatment by applying water streams at a pressure of 4 MPa and then naturally dried to give a hydroentangled nonwoven. The water streams are applied from a nozzle wherein orifices each having a 0.12 mm diameter are provided in a line at intervals of 0.6 mm.

(2) Determination of Splitting Rate

The nonwoven is folded to form a bundle wherein the machine direction of the nonwoven becomes a cross-section without gap. The cross-section are enlarged 300 times by an electronic microscope and pictures are taken at three points of. Next, the total area of the pictures is regarded as a matrix area for determining the splitting rate. Next, area occupied by fibers that are completely split into respective components and the area is divided by the matrix area, and then the quotient is multiplied by 100 to obtain the splitting rate.

The ultrafine fiber layer is preferably formed by subjecting a fiber web containing the first splittable conjugate fiber and the second splittable conjugate fiber at a mass ratio of 8:2 to 3:7 (the first splittable conjugate fiber: the second splittable conjugate fiber) to hydroentangling treatment as described below. More preferably, the mass ratio of the first splittable conjugate fiber to the second splittable conjugate fiber is in a range of 7:3 to 4:6. If the ratio of the first splittable conjugate fiber is less than 30% by mass of the total mass of the first and the second splittable conjugate fibers, the content of the ultrafine fibers “VA” is reduced, whereby the liquid remains tends to be increased. If the ratio of the first splittable conjugate fiber is over 80% by mass of the total mass of the first and the second splittable conjugate fibers, the content of the ultrafine fibers other than the ultrafine fibers “VA” is decreased, whereby the handling ability may be lowered or the fibers may be liable to fall. The ultrafine fiber layer may contain two or more types of the first splittable conjugate fibers. For example, two or more types of the first splittable conjugate fibers may be used, wherein the resins combined with the modified vinyl alcohol resin in the respective types are different from each other and/or the modified vinyl alcohol resins in the respective types are different from each other. In that case, the total mass of two or more first splittable conjugate fibers satisfies the preferable range as described above. Also, two or more types of the second splittable conjugate fibers may be included in the ultrafine fiber layer. In that case, the total mass of two or more types of the second splittable conjugate fibers satisfies the preferable range as described.

Herein, the reason why the ultrafine fiber layer is defined by the proportions of the splittable conjugate fibers that are not yet subjected to the hydroentangling treatment is that it is difficult to determine the proportion of ultrafine fibers when the splittable conjugate fibers are not split into respective components completely. In other word, the preferable ratio of the splittable conjugate fibers in the fiber web corresponds to the preferable ratio of the fibers resulting from the first splittable conjugate fibers (including the ultrafine fibers and the unsplit fibers) and the fibers resulting from the second splittable conjugate fibers (including the ultrafine fibers, the fibers melted by thermal bonding, and the unsplit fibers) in the ultrafine fiber layer constituting the wiping sheet.

The ultrafine fiber layer may contain another fiber(s) in addition to the first splittable conjugate fibers and the second splittable conjugate fibers as long as the effect of the present invention is not ruined. The another fiber(s) include a natural fiber such as cotton, pulp and flax; a regenerated fiber such as viscose rayon, solvent spinning cellulose, and Cupra; a polyester fiber made of, for example, polyethylene terephthalate, polybutylene terephthalate, polytrimethylene terephthalate or polybutylene succinate; a polyamide made of, for example, nylon 6 or nylon 66, a polyolefin fiber made of, for example, polyethylene, or polypropylene; and an acrylic fiber. The ultrafine fiber layer may contains a third splittable conjugate fiber that is different from the first splittable conjugate fiber and the second splittable conjugate fiber whose one component is the thermoadhesive resin, in addition to these first and second conjugate splittable fibers. That is, the ultrafine fiber layer may contain the third splittable conjugate fiber which does not contain the modified vinyl alcohol resin or the thermoadhesive resin as the component.

In the wiping sheet of Embodiment 1, the ultrafine fiber layer exists in a form of a nonwoven wherein the constituent fibers are entangled by a hydroentangling treatment. A method for producing the wiping sheet of this form, which method includes the hydroentangling treatment, is described.

Firstly, the first splittable conjugate fiber and the second splittable conjugate fiber, and optionally another fiber(s) are prepared and a fiber web is made. The fiber web may be any of, for example, a carded web (for example, a parallel-laid web, a random-laid web, a semirandom-laid web, cross-laid web, and crisscross-laid web), an airlaid web, a wetlaid web, a spunlaid web, and a meltblown web. The fiber web is preferably the carded web from the viewpoint of the entanglement of the fibers by the hydroentangling treatment.

The mass per unit area of the fiber web is preferably in a range of 25 g/m² to 100 g/m². A more preferable mass per unit area is in a range of 30 g/m² to 80 g/m². If the mass per unit area is less than 25 g/m², the uniformity of the nonwoven is liable to be deteriorated. If the mass per unit area is over 100 g/m², the handling ability when using the nonwoven as the wiping sheet tends to be lowered, and the cost may be high. The mass per unit area of the fiber web can be regarded as almost the same as the mass per unit area of the fiber web after the hydroentanglement (that is, the ultrafine fiber layer) even if the ultrafine fibers in one layer somewhat moves to another ultrafine fiber layer or the fibers somewhat fall during the hydroentangling treatment. Therefore, the preferable mass per unit area of the fiber web mentioned herein corresponds to the preferable mass per unit area of the ultrafine fiber layer in the wiping sheet. This is applicable to other embodiments described below.

Next, the fiber web is placed on a web-conveying supporting member and subjected to the hydroentangling treatment by application of water streams on one or both surfaces of the fiber web. During this treatment, the first splittable conjugate fibers and the second splittable conjugate fibers are split and entangled to form an integrated body, whereby a hydroentangled nonwoven is obtained. The conditions for the hydroentangling treatment can be selected depending on the mass per unit area of the nonwoven to be obtained. For example, water streams may be applied once or 2 to 4 times on each surface of the web at a pressure of at least 3 MPa and at most 15 MPa from a nozzle wherein orifices each having a 0.05-0.5 mm diameter are provided at intervals of 0.5-1.5 mm. Before the hydroentangling treatment, a preliminary entangling treatment may be optionally carried out by applying a low-pressure water streams (for example, 1 MPa), or a thermal embossing treatment may be carried out. After the hydroentangling treatment, a drying treatment is carried out so as to obtain the wiping sheet.

In the case where the constituent fibers are bonded with the thermal adhesive ultrafine fibers obtained from the second splittable conjugated fibers and/or the thermal adhesive resin contained in the unsplit second splittable conjugate fibers, a thermal bonding treatment is carried out instead of the drying treatment or after the drying treatment. The thermal bonding treatment is carried out by a heat roller treatment or a hot air-through treatment. The temperature during the thermal bonding is preferably at least the melting point of the thermal adhesive resin constituting the second splittable conjugate fiber and at most ((the melting point of a resin which has the lowest melting point among the components of the first splittable conjugate fiber and the another resin(s) “B” constituting the second splittable conjugate fiber) −10° C.), and more preferably at the most ((the melting point of a resin which has the lowest melting point among the components of the first splittable conjugate fiber and the another resin(s) “B” constituting the second splittable conjugate fiber) −15° C.). By adjusting the thermal treatment temperature within this temperature range, it is possible to obtain the wiping sheet that is entirely soft and does not damage the object while rubbing against the object, and brings about the effect to be achieved by the present invention (the improvement in wet absorptiveness and wiping ability, and the decrease in liquid remains).

### Embodiment 2

As Embodiment 2, a wiping sheet is described, wherein a ultrafine fiber layer is formed by ultrafine fibers that are formed by eluting a portion of conjugate fibers which are composed of components different in solubility to a solvent (including water). The techniques of forming the ultrafine fibers by utilizing the difference of resins in solubility to solvent are known, and any of the techniques can be employed in this embodiment. The components whose solubilities to solvent are different from each other may be conjugate-spun so that, for example, a sea-island cross-sectional structure is obtained or the structure as shown in FIGS. 1 to 3 is obtained. Particularly, the sea-island conjugate fiber is advantageous in a manufacturing process, since such a fiber can be handled as a large-fineness fiber until the fiber is subjected to a solvent treatment.

In this embodiment, it is required that at least two types of ultrafine fiber-generating conjugate fibers are employed, and the ultrafine fibers “VA” containing the modified vinyl alcohol resin are obtained from at least one conjugate fiber and at least one ultrafine fiber containing another resin is obtained from the other conjugate fibers (hereinafter, the ultrafine fiber obtained from the conjugate fiber which does not generate the ultrafine fiber “VA” is referred to as an “ultrafine fiber “C””). This makes it possible to obtain a construction wherein the ultrafine fibers “VA” and the ultrafine fibers “C” are randomly laid, and enables the ultrafine fibers “C” to serve as the skeleton. Further, in the case where the ultrafine fibers “VA” and at least one type of ultrafine fibers “C” are generated from different ultrafine fiber-generating conjugate fibers and entangled by, for example, the hydroentangling treatment, two or more types of ultrafine fibers are entangled well and the skeleton-function of the ultrafine fiber “C” is more effectively exerted. On the contrary, when, for example, the ultrafine fibers “VA” and the ultrafine fibers “C” are generated from one type of the ultrafine fiber-generating conjugate fiber (including the splittable conjugate fiber), these ultrafine fibers tend to exist in a form of bundle and the skeleton-function of the ultrafine fibers “C” is not exerted sufficiently. Further, in that case, intricate entanglement of two types of fibers cannot be achieved, even if the fibers are subjected to the entangling treatment. Further, a wiping sheet wherein fibers of a large fineness are used as the skeleton for the ultrafine fiber layer shows increased liquid remains. The wiping sheet of the present invention including this embodiment is characterized in that the fibers for reinforcing the ultrafine fibers “VA” whose strength is small are also ultrafine fibers and a part or all of the reinforcing fibers are generated from fibers which are different from the ultrafine fiber-generating conjugate fibers that generate the ultrafine fibers containing the modified vinyl alcohol resin. It should be noted that the ultrafine fibers obtained from the second splittable conjugate fibers as described in connection with Embodiment 1 (specifically, the ultrafine fibers “B” and the thermoadhesive ultrafine fibers) correspond to the ultrafine fibers “C” mentioned above, that is, the ultrafine fibers which are obtained from the fiber which are different from the ultrafine fiber-generating conjugate fibers (the first splittable conjugate fibers) that generate the ultrafine fibers “VA”.

In this embodiment, the ultrafine fibers may be obtained by carrying out the solvent treatment after a woven fabric or a knitted fabric has been manufactured using spun yarns or filament yarns made of the sea-island fibers. The woven fabric may be manufactured using the ultrafine fiber-generating conjugate fibers which give the ultrafine fibers “VA” as warps, and using the ultrafine fiber-generating conjugate fibers which give the ultrafine fibers “C” as warps. Further, for example, a warp knit may be manufactured by using these two types of yarns as warps alternately. In these cases, the disposition of the ultrafine fibers “C” is more regular (that is, less random) compared to the case of a nonwoven. The reinforcing effect of the ultrafine fibers “C”, however, is exerted by entanglement of the ultrafine fibers “VA” and the ultrafine fibers “C” at intersection points of the woven or the knitted fabric. In addition, since the strength of the woven or the knitted fabric is larger than the nonwoven due to their structure, such construction is permitted. Preferably, both of the warp and the weft are a blended filament yarn, an alternating-twisted yarn or a blended yarn which is made of two or more types of the ultrafine fiber-generating fibers. When the two or more types of conjugate fibers are formed into any of these yarn forms, the entangling points of the conjugate fibers is increased, and thereby the reinforcing effect of the ultrafine fibers “C” is more enhanced. Preferable materials and constitution of the ultrafine fiber “VA” are as described above in connection with the first splittable conjugate fiber and therefore the detailed description thereof is omitted here. Preferable materials and constitution of the ultrafine fiber “C” are the same as those of the ultrafine fibers “A” and “B” which are described in connection with the first and the second splittable conjugate fibers, and therefore the detailed description thereof is omitted here. The woven fabric or the knitted fabric may contain two or more types of the ultrafine fibers “C” and thereby the desired property can be easily conferred to the woven fabric or the knitted fabric. Alternatively, the woven fabric or the knitted fabric may contain the thermoadhesive ultrafine fibers. In that case, the thermoadhesive ultrafine fibers may bond thermally the other constituent fibers. As a result, the strength of the woven fabric or the knitted fabric can be more increased.

Alternatively, the ultrafine fiber layer may be formed as a nonwoven by using the conjugate fibers composed of components different in solubility to a solvent. In that case, it is preferable that ultrafine fibers containing a thermoadhesive resin are included in the ultrafine fiber layer and the constituent fibers of the fine layer are thermally bonded by the thermoadhesive resin. When the constituent fibers are not bonded in the nonwoven, the fibers may be liable to fall. When the conjugate fibers composed of components different in solubility to a solvent are used, the thermoadhesive ultrafine fibers may be obtained from the ultrafine fiber-generating conjugate fibers that give the ultrafine fibers “VA” or the conjugate fibers which give the ultrafine fibers “C.” The thermoadhesive ultrafine fibers are preferably obtained from other conjugate-fibers which give only the thermoadhesive ultrafine fibers, whereby the ultrafine fiber layer wherein the fiber laying is more random can be obtained. The case where the splittable conjugate fibers are used is as described above in connection with Embodiment 1. The preferable construction of the thermoadhesive ultrafine fiber is as described in connection with the second splittable conjugate fiber, and therefore the detailed description thereof is omitted here. The nonwoven may be obtained by forming a fiber web as exemplified in conjunction with Embodiment 1 and subjecting the fiber web to the hydroentangling treatment or a needle punching treatment so as to entangle the fibers followed by subjecting the web to the solvent treatment to form the ultrafine fibers and further subjecting the web to the thermal bonding treatment. Alternatively, the nonwoven may be a wetlaid nonwoven.

### Embodiment 3

As Embodiment 3, a wiping sheet composed of a plurality of ultrafine fiber layers. The wiping sheet of the present invention may be of a construction wherein a plurality of ultrafine fiber layers as described in connection with Embodiment 1 are stacked. In that case, two or more ultrafine fiber layers may be preferably formed of fiber webs whose ratios of the first splittable conjugate fiber to the second splittable conjugate fiber are different from each other, whereby a desired property can be conferred to the nonwoven.

The wiping sheet having two or more ultrafine fiber layers is preferably a three-layer structure which is composed of ultrafine fiber layers “SU” that constitute the nonwoven surfaces which contacts with a surface of an object, and a ultrafine fiber layer “IN” that constitutes the inner of the nonwoven. In that case, more fibers which result from the second splittable conjugate fibers preferably exist in the surfaces of the nonwoven and more fibers which result from the first splittable conjugate fibers preferably exist inside the nonwoven. Fluffing is thereby suppressed since the lint from the nonwoven surface is reduced. Further, the slipperiness of the wiping sheet is improved. At the same time, the greasy dirt can be wiped off and absorbed by utilizing the capillary action of the ultrafine fibers “VA” which exist at a greater ratio inside the nonwoven, and the liquid remains on the surface of the object can be reduced.

Specifically, the ultrafine fiber layer “SU” may be preferably obtained from a fiber web which contains the first splittable conjugate fibers and the second splittable conjugate fibers at a mass ratio of 7:3 to 1:9 (the first splittable conjugate fibers: the second splittable conjugate fibers). Further, the ultrafine fiber layer “IN” may be preferably obtained from a fiber web which contains the first splittable conjugate fibers and the second splittable conjugate fibers at a ratio of 10:0 to 5:5 (the first splittable conjugate fibers: the second splittable conjugate fibers). The ultrafine fiber layer “SU” may be more preferably obtained from a fiber web wherein the ratio of the first splittable conjugate fibers to the second splittable conjugate fibers is 5:5 to 2:8. The ultrafine fiber layer “IN” may be more preferably obtained from a fiber web wherein the ratio of the first splittable conjugate fibers to the second splittable conjugate fibers is 10:0 to 6:4 and still more preferably 8:2 to 6:4.

The first splittable conjugate fiber and the second splittable conjugate fiber which constitute the two or more ultrafine fiber layers are as described in connection with Embodiment 1, and therefore the detailed description is omitted here.

When the wiping sheet is formed of two or more ultrafine fiber layers, a laminate web which is obtained by stacking two or more fiber webs is subjected to the hydroentangling treatment as described above. For example, when the ultrafine fiber layers “SU” and “IN” are formed by two types of fiber webs which contain the two types of splittable conjugate fibers at the ratio as described above, the mass per unit area of the fiber web for the layer “SU” is preferably in a range of 5 g/m² to 30 g/m², and the mass per unit area of the fiber web for the layer “IN” is preferably in a range of 5 g/m² to 70 g/m². The layers whose mass per unit areas are in these ranges effectively form the three-layer structure. As a result, the lint and the fluffing are suppressed in the surface of the wiping sheet, and good wiping ability and less liquid remains is achieved because the wettability of the fibers inside the nonwoven is exerted effectively.

The hydroentangling treatment conditions are as described in connection with Embodiment 1, and therefore the detailed description is omitted here. Further, the thermal treatment conditions for thermally bonding the constituent fibers with the thermoadhesive resin contained in the second splittable conjugate fibers are described as above in connection with Embodiment 1, and therefore the detailed description is omitted here.

### Embodiment 4

As Embodiment 4, a wiping sheet which include a hydrophilic fiber layer and the ultrafine fiber layers are laminated on both surfaces of the hydrophilic fiber layer.

When the wiping sheet includes the hydrophilic fiber layer, it is preferable that amount of the hydrophilic fibers contained in the ultrafine fiber layer is small so that less hydrophilic fibers are exposed on the surfaces of the ultrafine fiber layers, whereby the wiping sheet presents good water absorptivity and less liquid remains. For this reason, it is preferable that the hydrophilic fiber layer is formed of a nonwoven wherein the hydrophilic fibers are point-bonded and/or entangled, and the point-bonded areas or the fiber entangling areas that are formed before the hydrophilic fiber layer is integrated with the ultrafine fiber layer are maintained in the hydrophilic layer after the integration. Therefore, the hydrophilic fiber layer is required to be a nonwoven which can be handled, before the hydroentangling treatment, as an independent sheet. The hydrophilic fiber layer before the lamination, that is a hydrophilic nonwoven, is described below.

The hydrophilic nonwoven preferably contains regenerated cellulose fibers which self-bond each other. Herein, the “regenerated cellulose fiber” refers to viscose rayon, cupraammonium rayon (Cupra), and a solvent spinning cellulose fiber. Further, the phrase “regenerated cellulose fibers which self-bond each other” means that a part of the regenerated cellulose fibers melts and soften to bond each other without an adhesive. Such bonding may be achieved by modifying the part of the regenerated cellulose fibers, or utilizing the viscosity of the regenerated cellulose fibers immediately after spinning.

Specifically, as the hydrophilic nonwoven, a nonwoven can be exemplified, which are produced by making a fiber web containing rayon staple fibers which have portions of methylolized derivative of cellulose xanthate and carrying out thermocompression bonding so as to melt the methylolized derivative of cellulose xanthate by means of an embossing roller, whereby the point-bonded areas are formed. This nonwoven is preferably formed of such rayon staple fibers alone. In the case where the nonwoven with the point-bonded areas is subjected to the hydroentangling treatment, the fiber entangling areas are further formed in this nonwoven. The nonwoven formed of rayon staple fibers and having point-bonded areas, and the nonwoven formed of rayon staple fibers and having the point-bond areas and the fiber entangling areas are commercially available under the trade name of “Taiko TCF” from Futamura Chemical Co., Ltd. “Taiko TCF” is described in “Nonwoven Information” (pp 22 -23, Nonwovens Co., Mar. 10, 2004) and this article is incorporated by reference into this specification.

In the hydrophilic nonwoven, the point-bonded areas are preferably formed at a rate of 10-60 points (or counts) per square centimeter and they preferably occupy 5% to 60% of the surface of the nonwoven. When the numbers and the proportion of the point-bonded areas are small, more hydrophilic fibers are liable to be contained in the ultrafine fiber layer, whereby the effect of the present invention may be not achieved. When the numbers and the proportion of the point-bonded areas are large, the bonding strength between the hydrophilic nonwoven and the ultrafine fiber layer is liable to be small.

Alternatively, the hydrophilic nonwoven is preferably a filament nonwoven formed by spinning the regenerated cellulose filaments and partially bonding the fibers while the spun filaments have tackiness. This filament nonwoven is also preferably formed of the regenerated cellulose fibers alone. When the filament nonwoven is subjected to the hydroentangling treatment, it becomes a nonwoven having the fiber-entangled areas. The filament nonwoven formed of the regenerated cellulose fibers alone is commercially available under the trade name “Bemliese” from ASAHI KASEI FIBERS CORPORATION and the trade name “BEMCOT” from Ozu Corporation. The “Bemliese” and “BEMCOT” are the nonwovens formed of only Cupra. The nonwovens marketed under these trade name include various forms, for example, a nonwoven having fiber-entangled areas formed by the hydroentangling treatment.

Alternatively, the filament nonwoven may be one wherein the filaments do not bond each other and the filaments are entangled by, for example, the hydroentangling treatment to construct a sheet form. Such a filament nonwoven may constitute the hydrophilic fiber layer having the fiber-entangled areas. When the hydrophilic layer is a layer containing the hydrophilic filaments, the hydrophilic fiber layer before being integrated with the ultrafine fiber layer may be a filament web wherein the filaments do not bond each other or are not entangled. Since such a filament web is difficult to be handled as an independent sheet, the wiping sheet is produced by a method wherein the filament web is integrated with the ultrafine fiber layer immediately after the formation of the filament web.

The mass per unit area of the hydrophilic nonwoven is preferably in a range of 10 g/m² to 180 g/m², and more preferably in a range of 15 g/m² to 60 g/m². If the mass per unit area of the hydrophilic nonwoven is less than 10 g/m², good water absorptivity is not conferred to the wiping sheet and the uniformity of the wiping sheet may be deteriorated. If the mass per unit area of the hydrophilic nonwoven is over 180 g/m², the wiping sheet including this nonwoven as the hydrophilic layer presents enhanced water absorptivity, but the liquid may outflow from the wiping sheet by pressing the sheet when a large amount of liquid is retained in the hydrophilic fiber layer. The outflown water may cause the liquid remains. Herein the preferable mass per unit area of the hydrophilic nonwoven is described. The mass per unit area of the hydrophilic nonwoven may be regarded as almost the same as that of the hydrophilic fiber layer in the final wiping sheet, even if mass per unit area of the hydrophilic nonwoven is somewhat reduced by the movement of the hydrophilic fibers to the ultrafine fiber layer during the hydroentangling treatment. Therefore, it should be noted that the preferable range of the mass per unit area of the hydrophilic nonwoven is the preferable range of the hydrophilic fiber layer in the wiping sheet.

The first splittable conjugate fiber and the second splittable conjugate fiber constituting the ultrafine fiber layer laminated on both surfaces of the hydrophilic fiber layer, and the preferable mixing ratio of these conjugate fibers are as described in connection with Embodiment 1, and therefore the detailed description thereof is omitted.

The mass per unit area of the ultrafine fiber layer is preferably in a range of 5 g/m² to 100 g/m², and more preferably in a range of 5 g/m² to 40 g/m². If the mass per unit area of the ultrafine fiber layer is less than 5 g/m², the uniformity of the wiping sheet may be deteriorated, and the wiping ability for greasy dirt may be lowered. If the mass per unit area of the ultrafine fiber layer is over 100 g/m², the water absorptivity of the entire wiping sheet tends to be lowered.

The hydroentangling treatment is carried out on a laminate wherein fiber webs which are to constitute the ultrafine fiber layers are laminated on both surfaces of the hydrophilic fiber layer. The hydroentangling treatment conditions are as described in connection with Embodiment 1, and therefore the detailed description thereof is omitted here. Further the thermal treatment conditions for thermally bonding the constituent fibers with the thermoadhesive resin contained in the second splittable conjugate fibers are also as described in connection with Embodiment 1, and therefore the detailed description thereof is omitted here.

All of the wiping sheets of Embodiments 1 to 4 may be used as a dry-type wiping sheet. In that case, liquid paraffin may be soaked in the wiping sheet. The dry-type wiping sheet may used as a sheet for removing dirt or liquid from a surface of an object or may be used to apply wax to furniture, floor, or a car, or may be used to apply cosmetic material to skin.

Further, a wetting agent may be applied to any of the wiping sheets of Embodiments 1 to 4 by impregnation, spraying or coating, so that the wiping sheet is used as a wet wiping sheet. Herein, the wetting agent means a liquid which wets the wiping sheet, and the agent is, for example, water, an alcohol, various functional agents (for example, a surfactant, a detergent, an antiseptic agent, an antifogging agent, and cosmetic material) or a mixture thereof. The wetting agent may be applied in an amount of 1000 or less parts by mass, more preferably 50-500 parts by mass, and further more preferably 50-300 parts by mass, to the nonwoven of 100 parts by mass. The wet wiping sheet may be used as a sheet for removing dirt or may be used to apply the liquid with which the wiping sheet is impregnated to the object (including a person).

More specifically, when the wet wiping sheet is used as a wiping sheet for OA equipment, a wetting agent containing 5-30% by mass of an alcohol (particularly, ethanol), 0.1-1.0% by mass of a detergent, 0.3-1.0% by mass of an antiseptic agent (particularly, paraben) and purified water for the rest is preferably applied to the wiping sheet. When the wet wiping sheet is used as a wiping sheet for cleaning a window, a wetting agent containing 5-30% by mass of an alcohol (particularly, ethanol), 0.1-1.0% by mass of a detergent, 0.5-2.0% by mass of an antiseptic agent (particularly, an industrial antiseptic agent), 0.05-0.2% by mass of a chelating agent, 1.0-5.0% by mass of a moisturizing agent and purified water for the rest is preferably applied to the wiping sheet.

The wiping sheet of the present invention may be preferably used as an a wiping sheet for things or a person to remove the dirt or greasy dirt from the things such as OA equipment such as a display, glasses, cars, kitchen, shoes, or a person, or may be preferably used as a wiping sheet in the clean room since the amount of dust emission is small during a wiping operation. Alternatively, the wiping sheet of the present invention may be preferably used as a cleansing sheet for removing cosmetic material from a face of a man or a woman, or a nail remover for removing nail lacquer. Alternatively, the wiping sheet of the present invention may be used as an application sheet for applying wax or a coating agent.

### EXAMPLES

Hereinafter, the wiping sheet of the present invention is described by examples. In the following examples, the thickness, the tensile strength, the rupture elongation, the splitting rate, the wiping ability, the liquid remains, the lint, and the wettability of the wiping sheet are determined as described below.

[Thickness]

The thickness is measured with a thickness meter (manufactured by Daiei Kagaku Seiki Seisakusho Co., Ltd., trade name: THICKNESS GAUGE model CR-60A) under a load of 2.94 cN/cm² of the sample.

[Tensile Strength and Rupture Elongation]

A sample piece of 5 cm in width and 15 cm in length is held at a grasp interval of 10 cm and extended at a pulling rate of 30 cm/min with a constant speed extension tensile tester (manufactured by ORIENTEC Co., LTD, trade name: TENSILON) in accordance with JIS L-1096. The values of load and extension at break are taken as tensile strength and rupture elongation.

[Splitting Rate: For Samples 13-18 and Comparative Sample C]

The laminate wiping sheet was folded to form a bundle wherein the machine direction of the nonwoven becomes a cross-section without gap. The cross section was enlarged 300 times by an electronic microscope and pictures were taken at three points. Next, the area occupied by the fibers (such as hydrophilic fibers) other than the splittable conjugate fibers was subtracted from the total areas of the pictures, and the value was regarded as a matrix area for determining the splitting rate. Next, area occupied by fibers that were completely split into respective components and the area was divided by the matrix area, and then the quotient was multiplied by 100 to obtain the splitting rate.

[Wiping Ability]

(a) Wiping Ability for Dirt

The nonwoven was cut into a size of 30 cm in the machine direction (the longitudinal direction) and 21 cm in the width direction, and the nonwoven of 100 parts by mass was impregnated with water of 200 parts by mass and thereby a wet wiping sheet was obtained. The wiping sheet was folded in quarters and moved back and forth three times on a glass surface of 30 cm×50 cm where dirt was applied previously and then how the dirt was wiped off was observed and evaluated on the grade of four scales of ◯, ◯-Δ, Δ, and X. The criteria for evaluation were as follows:
◯: All dirt was removed clean.
◯-Δ: Dirt was almost removed.
Δ: Some dirt remained.
X: Much dirt remained.

(b) Wiping Ability for Greasy Dirt

The nonwoven was cut into a size of 20 cm in the machine direction and 15 cm in the width direction. This nonwoven was used in a dry condition (DRY), or used as a i) wet wiping sheet (WET: water base) wherein the nonwoven of 100 parts by mass was impregnated with water of 200 parts by mass, or ii) wet wiping sheet (WET: alcohol base) wherein the nonwoven of 100 parts by mass was impregnated with a wetting agent for an OA cleaner of 200 parts by mass, the wetting agent containing 10% by mass of ethanol, 0.1% by mass of a detergent, 0.3% by mass of paraben as an antiseptic agent, and purified water for the rest.

Next, a square frame of 10 cm×10 cm was drawn on a center of a glass plate (30 cm×50 cm) with an oil-based ink and an artificial dust wherein an oil and test powders Class 12 prepared according to the specifications in JIS Z 8901 (purchased from The Association of Powder Process Industry and Engineering) were mixed at a mass ratio of 95:5 was dropped off and the dust was uniformly coated by a brush of a 45 mm width within the frame. Herein, as the oil, 1) Daphne Mechanic Oil 46 (Idemitsu Kosan Co., Ltd.), 2) artificial sebum (composition: squalane 16.1% by mass, triolein 31.2% by mass, oleic acid 46% by mass, liquid paraffin 6.7% by mass), and 3) olive oil (manufactured by Wako Pure Chemical Industries, Ltd., product number 150-00276) were employed. The oil was selected depending on the samples.

The DRY or WET sample was folded into quarters of a rectangular of 10 cm×7.5 cm and placed so that the side of 10 cm was brought into line with the frame drawn by the ink, and moved back and forth three times on the dust, and then the remains of the dirt was observed and the wiping ability was evaluated. The wiping ability was evaluated based on the grade of the following five scales.
◯: No dirt remained on the glass surface.
◯-Δ: A slight amount of dirt remained on the glass surface.
Δ: A small amount of dirt remained on the glass surface.
Δ-X: Much dirt remained on the glass surface.
X: Dirt on the glass surface cannot be removed.

[Liquid Remains]

A wiping sheet sample was obtained by cutting the nonwoven into a size of 20 cm in the machine direction and 15 cm in the width direction. A water droplet of 5 cc was dropped on a glass surface of 30 cm×50 cm using a dropper and the wiping sheet folded in quarters was moved back and forth three times on the water droplet. After the movement of the wiping sheet, the water droplets which remained on the glass surface was observed and evaluated on the grade of the following five classifications. The liquid remains was determined by the mean classification of n=2.
Class 1: Much liquid remains was observed, the water droplets were considerably large, and water stain was visible when dried.
Class 2: Liquid remains was observed, the water droplets were large, and water stain was observed when dried.
Class 3: Liquid remains was observed from place to place, the water droplets are small, and water stain was somewhat observed when dried.
Class 4: A little liquid remains was observed, the water droplets are small, and water stain was unnoticeable when dried.
Class 5; No liquid remains was observed, and no water stain occurred when dried.

[Lint]

A sample was obtained by cutting into the size of 30 cm in the machine direction and 21 cm in the width direction. The cut sample was folded into quarters (about 15 cm long and about 30 cm wide) and moved back and forth on an area of 10 cm short side and 30 cm long side for five minutes from one short side to the other short side of the glass surface while the direction parallel to the width direction of the nonwoven was the traveling direction. After the movement, the lint on the glass surface was observed and evaluated on the grade of four scales.
⊚: No or little lint existed.
◯: A little lint existed in the vicinity of the short sides on the glass surface.
Δ: Considerable amount of lint existed in the vicinity of the short sides on the glass surface.
X: Considerable amount of lint existed in the vicinity of the short sides and the long sides on the glass surface.

[Wettability]

Wettability was evaluated in accordance with the following procedures. When the wiping sheet is used as a wet wiping sheet and it does not have an appropriate wettability, it becomes a wiping sheet showing much liquid remains.

(1) A wiping sheet in a dry condition was prepared.

(2) A solution containing ethanol of 25% by mass and distilled water of 75% by mass was prepared.

(3) The solution of 500 ml was put into a commercially available atomizer.

(4) The solution was sprayed by the atomizer three times on a surface of the wiping sheet and then the surface of the nonwoven was observed and evaluated on the grade of the three scales.
◯: The solution penetrated inside the nonwoven, and the solution did not remain on the nonwoven surface.
Δ: The penetration of the solution inside the nonwoven was not so good, and the liquid droplets remained from place to place on the nonwoven surface.
X: The penetration of the solution inside the nonwoven was bad, and all the liquid droplets remained on the nonwoven surface.

[Water Absorption Speed and Water Absorptivity]

Water absorption speed was determined by a Byreck Method according to JIS-1096 6.26.1 B and water absopritive was determined by a dropping method according to JIS-1096 6.26.1 A.

[Samples 1-3 and Sample 5]

As a first splittable conjugate fiber containing a modified vinyl alcohol resin, a sixteen-segment splittable conjugate fiber was prepared, wherein a first component (a modified vinyl alcohol resin component) was an ethylene-vinyl copolymer (ethylene content was 38 mol % and vinyl alcohol content was 62 mol %) and a second component was a polypropylene resin. The fineness and the fiber length of the fiber were 3.3 dtex and 45 mm, and the cross-section thereof was as shown in FIG. 1(b). On the other hand, as a second splittable conjugate fiber, an eight-segment splittable conjugate fiber was prepared, wherein a first component was a high-density polyethylene resin and a second component was a polyethylene terephthalate resin. The fineness and the fiber length of the fiber were 2.2 dtex and 51 mm and the cross-section was as shown in FIG. 1(a).

Next, the first splittable conjugate fibers and the second splittable conjugate fibers were mixed at a ratio shown in Table 1 and a carded web of 40 g/m² was prepared using a parallel carding machine. Next, the carded web was placed on an 80-mesh plain weave with a warp-filament size of 0.2 mm and a weft-filament size of 0.2 mm as a conveying supporting member, and the web was subjected to a hydroentangling treatment. In the treatment, water streams were applied at a water pressure of 2.5 MPa twice from a nozzle which were provided with orifices of a 0.12 mm diameter at an interval 1 mm in a line in a direction of the width of the web, and the web is reversed and water streams were applied at a water pressure of 4 MPa twice from the same nozzle.

Next, the hydroentangled nonwoven was dried and thermally treated at the same time by means of a hot-air machine of which temperature was set at 140° C., so that thermoadhesive ultrafine fibers obtained by the split of the second splittable conjugate fibers and/or the thermoadhesive resin constituting the second splittable conjugate fibers bonded the other fibers, and thereby a wiping sheet of the present invention was obtained.

[Sample 4]

A wiping sheet was obtained according to the same procedures as those employed in producing Sample 1 except that 16-segment splittable conjugate fiber wherein the first component was a high-density polyethylene resin and the second component was a polypropylene was used as the second splittable conjugate fiber. The fiber had the fineness of 2.2 dtex and the fiber length of 51 mm and a cross-section as shown in FIG. 1(b).

[Samples 6-9]

A three-layer wiping sheet was produced, which composed of ultrafine fiber layers “SU” that are placed on the surfaces of a nonwoven, and an ultrafine fiber layer “IN” that is placed inside the nonwoven. Specifically, the ultrafine fiber layer “SU” was produced by blending the first splittable conjugate fibers and the second splittable conjugate fibers, both of which were the same as those employed in producing Sample 1, at a ratio shown in Table 2 and making a web of 10 g/m² with a parallel carding machine. The ultrafine fiber layer “IN” was produced by blending the same splittable conjugate fibers at a ratio shown in Table 2 and making a web of 20 g/m² with the parallel carding machine. The hydroentangling treatment and the thermal bonding treatment were carried out on the same conditions as those employed in producing Sample 1, and thereby a wiping sheet was obtained.

[Comparative Sample A]

A wiping sheet was obtained according to the same procedures as those employed in producing Sample 1, except that the nonwoven was produced using only the second splittable conjugate fibers (100 mass %) without the first splittable conjugate fibers.

[Comparative Sample B]

A wiping sheet was obtained according to the same procedures as those employed in producing Sample 1, except that polyethylene terephthalate fibers (PET) having a fineness of 1.7 dtex and a length of 38 mm (manufactured by Toray Industries, Inc., trade name “Tetoron”) was used instead of the second splittable conjugate fiber. The evaluation results of Samples 1 to 5 are shown in Table 1 and the evaluation results of Samples 6 to 9 are shown in Table 2 and the evaluation results of Comparative Samples A and B are shown in Table 1.

TABLE 1

| | | | | | | | Comparative | |
|---|---|---|---|---|---|---|---|---|
| | | Samples | | | | | Samples | |
| | | 1 | 2 | 3 | 4 | 5 | A | B |
| First splittable | (mass %) | 80 | 60 | 40 | 50 | 30 | 0 | 50 |
| conjugate fiber | | | | | | | | |
| Second splittable | (mass %) | 20 | 40 | 60 | 50 | 70 | 100 | 0 |
| conjugate fiber | | | | | | | | |
| Other fibers | (mass %) | 0 | 0 | 0 | 0 | 0 | 0 | 50 |
| Mass ratio (First:Second) | | 8:2 | 6:4 | 4:6 | 5:5 | 3:7 | 0:10 | Non |
| Mass per unit area | (g/m²) | 38 | 41 | 41 | 40 | 40 | 41 | 39 |
| Thickness | (mm) | 0.49 | 0.46 | 0.52 | 0.48 | 0.49 | 0.58 | 0.59 |
| Tensil strength | Machine | 67 | 79 | 81 | 62 | 89 | 89 | 51 |
| (N/5 cm) | direction | | | | | | | |
| | Cross- | 21 | 24 | 28 | 22 | 35 | 41 | 14 |
| | Machine | | | | | | | |
| | direction | | | | | | | |
| Rupture elongation | Machine | 31 | 28 | 22 | 46 | 20 | 15 | 59 |
| (%) | direction | | | | | | | |
| | Cross- | 119 | 112 | 108 | 145 | 96 | 84 | 181 |
| | Machine | | | | | | | |
| | direction | | | | | | | |

| | | | | | | | |
|---|---|---|---|---|---|---|---|
| Liquid remains | Class 5 | Class 5 | Class 4 | Class 5 | Class 4 | Class 1 | Class 1 |
| Wiping ability (for dirt) | ∘ | ∘ | ∘˜Δ | ∘˜Δ | Δ | x | ∘˜Δ |
| Lint | Δ | ∘ | ∘ | ∘ | ∘ | ⊚ | x |
| Wettablity | ∘ | ∘ | Δ | Δ | Δ | x | ∘ |

TABLE 2

| | | | Samples | | | |
|---|---|---|---|---|---|---|
| | | | 6 | 7 | 8 | 9 |
| Ultrafine fiber | First splittable | (mass %) | 10 | 20 | 30 | 10 |
| layer “SU” | fiber | | | | | |
| (Surface layer) | Second splittable | (mass %) | 90 | 80 | 70 | 90 |
| | fiber | | | | | |
| Ultrafine fiber | First splittable | (mass %) | 80 | 80 | 80 | 100 |
| layer | fiber | | | | | |
| “IN” (Internal | Second splittable | (mass %) | 20 | 20 | 20 | 0 |
| layer) | fiber | | | | | |

| Mass ratio in the entire nonwoven | | 45:55 | 50:50 | 55:45 | 55:45 |
|---|---|---|---|---|---|
| (First:Second) | | | | | |
| Mass per unit area | (g/m²) | 44 | 41 | 41 | 40 |
| Thickness | (mm) | 0.49 | 0.51 | 0.51 | 0.51 |
| Tensile strength | Machine | 72 | 73 | 77 | 81 |
| (N/5 cm) | direction | | | | |
| | Cross- | 30 | 31 | 37 | 35 |
| | machine | | | | |
| | direction | | | | |
| Rapture elongation | Machine | 28 | 25 | 20 | 29 |
| (%) | direction | | | | |
| | Cross- | 102 | 112 | 100 | 110 |
| | machine | | | | |
| | direction | | | | |

| | | | | |
|---|---|---|---|---|
| Liquid remains | Class 4 | Class 5 | Class 5 | Class 4 |
| Wiping ability (for dirt) | ∘˜Δ | ∘˜Δ | ∘˜Δ | ∘˜Δ |
| Lint | ⊚ | ⊚ | ⊚ | ⊚ |
| Wettablity | Δ | ∘ | ∘ | Δ |

Further, the dust emission of Sample 2 was evaluated by a tumbling method according to JIS B 9923-1997. The evaluation procedures were as follows. Firstly, a tumbling-type dust emission test machine was placed in a clean room (cleanliness: ISO class 5 (Class 100)) and idled to confirm that the inside of the test machine was in a non-dust state. Next, the sample was put in a drum of the test machine and the operation of the test machine was started. The test machine was CW-HDT-102 manufactured by Akado Co., Ltd. and the operation was conducted at a rotation speed of 46 revolutions per minute, and at a flow rate of 0.0102 m³ per second. After thirty (30) seconds elapsed since the start of operation, particles are counted with a particle counting device (Net One A 2400) at a speed of 0.0283 m³/min for one minute and the counting was carried out five times successively. The mean value of the counted particles except for the maximum value and the minimum value was determined as the emitted dust counts. The result is shown in Table 3.

TABLE 3

| | | The number of |
|---|---|---|
| | | separatable |
| | | particles |
| | | (counts/sec) |
| particle size | at least 0.3 μm - | 88.7 |
| classification | less than 0.5 μm | |
| | at least 0.5 μm - | 81.3 |
| | less than 1 μm | |
| | at least 1 μm - | 94.4 |
| | less than 5 μm | |
| | at least 5 μm - | 10.7 |
| | less than 10 μm | |
| | at least 10 μm - | 0.7 |
| | less than 25 μm | |
| | at least 25 μm | 0 |

Samples 1 to 5 were the nonwovens of a mono-layer structure wherein the first splittable conjugate fibers and the second splittable conjugate fibers are blended. Any of these samples was at a practicable level and Samples 2 and 4 particularly show excellent properties for the liquid remains, the wiping ability, the lint and the wettability. From the evaluation results of these samples, it is found that as the proportion of the first splittable conjugate fibers is larger in the nonwoven, the liquid remains is less and the wiping ability and the wettability are more improved, while the lint tends to increase.

Samples 6-9 were the nonwovens of a laminated structure which was composed of the ultrafine fiber layers “SU” constituting the surfaces and the ultrafine fiber layer “IN” constituting the inside. From the evaluation results of these samples, it was found that good properties for the liquid remains, the wiping ability and the wettability were obtained and the lint was suppressed by increasing the (mass) ratio of the second splittable conjugate fibers in the ultrafine fiber layer “SU” and increasing the (mass) ratio of the first splittable conjugate fibers in the ultrafine fiber layer “IN.” Particularly, Samples 7 and 8 were excellent in any of the properties.

Comparative Sample A did not tend to generate the lint, but was not at a practicable level for the other properties since the sample was composed of only the second splittable conjugate fibers without the first splittable conjugate fibers. Although Comparative Sample B contained the first splittable conjugate fibers, it contained the polyester fibers of a large fineness, whereby the sample showed much liquid remains and was not at a practicable level.

[Samples 10-13]

From the evaluation results of Samples 1 to 4, the wiping sheet which was prepared using a fiber web wherein the ratio of the first splittable conjugate fiber to the second splittable conjugate fiber was 6:4 represented most excellent properties among the samples. Four types of samples which contained the first and the second conjugate fibers at this ratio were then produced as Samples 10 to 13.

Samples 10 and 12 were produced according to the same procedures as those employed in producing Sample 1 except that the masses per unit area of the carded webs were 40 g/m² and 50 g/m² respectively, and the thermal treatment temperature was 100° C. As a result, a soft wiping sheet was obtained, wherein the thermoadhesive ultrafine fibers obtained by the split of the second splittable conjugate fibers and/or the thermoadhesive resin constituting the second splittable conjugate fibers did not bond the other fibers.

Samples 11 and 13 were produced according to the same procedures as those employed in producing Sample 1 except that the masses per unit area of the carded webs were 40 g/m² and 50 g/m² respectively. The samples had a higher rigidity than Samples 10 and 12. The evaluation results of Samples 10-13 are shown in Table 4.

TABLE 4

| | | | | Wiping ability | | | Wiping ability | | | Wiping ability | | | |
|---|---|---|---|---|---|---|---|---|---|---|---|---|---|
| | | | | (for greasy dirt *1) | | | (for greasy dirt *2) | | | (for greasy dirt *3) | | | |
| | Mass per | | | | WET | | | WET | | | WET | | |
| | unit area | Thickness | Liquid | | | Alcohol | | | Alcohol | | | Alcohol | |
| | (g/m²) | (mm) | remains | DRY | Water | base | DRY | Water | base | DRY | Water | base | Lint |
| Sample 10 | 40.1 | 0.41 | Class 3 | Δ | ∘˜Δ | ∘˜Δ | Δ | ∘˜Δ | ∘˜Δ | Δ | ∘˜Δ | ∘˜Δ | Δ |
| Sample 11 | 43.2 | 0.36 | Class 5 | ∘ | ∘ | ∘ | ∘ | ∘ | ∘ | ∘ | ∘ | ∘ | ⊚ |
| Sample 12 | 45.6 | 0.47 | Class 3 | Δ | ∘˜Δ | ∘˜Δ | Δ | ∘˜Δ | ∘ | ∘ | ∘˜Δ | Δ | Δ |
| Sample 13 | 47.4 | 0.56 | Class 5 | ∘ | ∘ | ∘ | ∘ | ∘ | ∘ | ∘ | ∘ | ∘ | ⊚ |

*1 Daphne Mechanic Oil
*2 Artificial sebum
*3 Olive oil

Since the fibers did not thermally bonded by the thermoadhesive resin in Samples 10 and 12, these samples were somewhat inferior in the liquid remains, the wiping ability and the lint compared to Samples 11 and 13, but Samples 10 and 12 were at a practicable level. Samples 11 and 13 were superior in any properties. Further, it was found that Samples 11 and 13 in a wet condition became soft and can be more easily handled. Next, a comparison test was carried out so as to compare the rigidity of Sample 11 in a dry condition and a wet condition.

Specifically, the rigidity of Sample 11 in a dry condition was compared to the rigidities of three types of Samples 11 in wet conditions. The three types of samples were obtained by impregnating 100 parts by mass of nonwovens with 200 parts by mass of water, an ethanol aqueous solution (ethanol of 20 mass % and water of 80 mass %), and a wetting agent for OA cleaner, respectively. The wetting agent for OA cleaner contained 10% by mass of ethanol, 0.1% by mass of a detergent, 0.3% by mass of paraben as an antiseptic agent, and purified water for the rest. Further, for Comparative Sample A, the rigidity in a wet condition was compared to that in a dry condition. The rigidity was determined using a handleometer (model type HOM-200, manufactured by Daiei Kagaku Seiki Seisakusho Co., Ltd.) according to JIS L 1069 6.19.5E. More specifically, a test piece of 15×17 cm was set on a slit of a 20 mm width perpendicular to the slit and the test piece was pushed by 8 mm at a position shifted by 6.7 cm from the side of the test piece (at a position of one third of the testing width) using a blade of a penetrator and a resistance value was measured as the stiffness. The resistance values during the push were measured at three different points for a machine direction (MD) and a cross-machine direction (CD) respectively, and the mean value of the measured values was evaluated as the stiffness for each direction. The evaluation results are shown in Table 5.

TABLE 5

| | | | Stiffness (g) | |
|---|---|---|---|---|
| | | | MD | CD |
| | | | direction | direction |
| Sample 11 | DRY | | 27.1 | 5.1 |
| | WET | Water | 13.9 | 3.6 |
| | | Ethanol aqueous | 14.6 | 4.0 |
| | | solution | | |
| | | Wetting agent | 19.0 | 4.3 |
| | | for OA cleaner | | |
| Comparative | DRY | | 12.4 | 3.5 |
| Sample A | WET | Ethanol aqueous | 18.7 | 8.5 |
| | | solution | | |

From this result, the wet samples had a small resistance value and became soften apparently. The resistance value of the wet Comparative Sample A was increased and the stiffness of this sample became large. The reason why the wet wiping sheet of Sample 11 was soft was considered that the modified vinyl alcohol resin absorbed the wetting agent and swelled, whereby the fibers themselves softened. This consideration, however, does not restrict the present invention.

[Sample 14]

The first splittable conjugate fibers and the second splittable conjugate fibers which were the same as employed in producing Sample 1 were blended at the ratio of 6:4 (mass ratio) and a carded web of 10 g/m² was produced using a parallel carding machine.

As a hydrophilic nonwoven, a thermocompression bonding nonwoven (trade name: Taiko TCF, manufactured by Futamura Chemical Co., Ltd.) of 20 g/m² was prepared. The nonwoven was composed of viscose rayon staple fibers and had point-bonded areas. The point-bonded areas were formed by fiber bonding due to melt of methylolized derivative of cellulose xanthate. In the nonwoven used in this sample, the point-bonded areas were provided at about 20 counts per cm², occupying about 25% of a surface of the nonwoven. The splittable conjugate-fiber webs are laminated on both surfaces of the hydrophilic-fiber nonwoven to give a laminate of 40 g/m². A hydroentangling treatment was carried out using the nozzle and the supporting member which were employed in producing Sample 1. The treatment was conducted by applying water streams at 2.5 MPa on one surface of the laminate once, and then reversing the laminate followed by applying the water streams at 4 MPa twice from the same nozzle. Further, a thermal treatment was carried out under the same conditions as those employed in producing Sample 1, whereby a wiping sheet was obtained.

[Sample 15]

A wiping sheet was produced according to the same procedures as those employed in producing Sample 14 except that the mass per unit area of the fiber web containing the splittable conjugate fibers was about 12.5 g/m² and the mass per unit area of the laminate was 45 g/m².

[Sample 16]

A wiping sheet was produced according to the same procedures as those employed in producing Sample 14 except that the mass per unit area of the fiber web containing the splittable conjugate fibers was about 15 g/m² and the mass per unit area of the laminate was 50 g/m².

[Sample 17]

A wiping sheet was produced according to the same procedures as those employed in producing Sample 14 except that the mass per unit area of the fiber web containing the splittable conjugate fibers was about 17.5 g/m² and the mass per unit area of the laminate was 55 g/m².

[Sample 18]

A wiping sheet was produced according to the same procedures as those employed in producing Sample 14 except that the mass per unit area of the fiber web containing the splittable conjugate fibers was about 7.5 g/m², the hydrophilic nonwoven was of the same construction as that of the nonwoven employed in producing Sample 14 and had a mass per unit area of 40 g/m², and the mass per unit area of the laminate was 55 g/m².

[Sample 19]

A wiping sheet was produced according the same procedures as those employed in producing Sample 14 except that a Cupra filament nonwoven of 25.5 g/m² wherein the fibers were partially bonded each other and the fiber-entangled areas were formed (trade name: BEMCOT, SF253 manufactured by Ozu Corporation) was used as the hydrophilic nonwoven.

[Comparative Sample C]

The hydrophilic nonwoven which was employed in producing Sample 14 was evaluated.

The evaluation results of Samples 14 to 19 and Comparative Sample C are shown in Table 6.

TABLE 6

| | | | | | Wiping ability | | | | Water absorption | | |
|---|---|---|---|---|---|---|---|---|---|---|---|
| | | | | | (for greasy | | | | speed | | |
| | Mass per | | Splitting | | dirt*1) | | | | (mm/10 min.) | | Water |
| | unit area | Thickness | rate | Liquid | | WET: | | Liquid | MD | CD | absorptivity |
| | (g/m²) | (mm) | (%) | remains | DRY | Water | Lint | wettablity | direction | direction | (Seconds) |
| Sample 14 | 42.5 | 0.59 | 85 | Class 4 | ∘˜Δ | ∘ | Δ˜x | ∘ | 12.5 | 8 | <2.0 |
| Sample 15 | 45.5 | 0.63 | 85 | Class 5 | ∘˜Δ | ∘ | Δ | ∘ | 12.5 | 8 | <50 |
| Sample 16 | 52.1 | 0.68 | 85 | Class 5 | ∘ | ∘ | Δ | ∘ | 12 | 9.5 | <60 |
| Sample 17 | 57.2 | 0.71 | 80 | Class 5 | ∘ | ∘ | ∘ | ∘ | 12.5 | 8.5 | <90 |
| Sample 18 | 56.3 | 0.68 | 85 | Class 3 | ∘˜Δ | ∘ | ∘˜∘Δ | ∘ | 16.5 | 14 | <1.0 |
| Sample 19 | 48.7 | 0.67 | 85 | Class 4 | ∘ | ∘ | Δ | ∘ | 13.5 | 12.8 | <3 |
| Comparative | 21.2 | 0.21 | — | Class 1 | Δ˜x | Δ˜x | x | ∘ | 6 | 9 | <1.0 |
| Sample C | | | | | | | | | | | |

*1Daphne Mechanic Oil

Any of Samples 14 to 19 was superior in the liquid remains, the wiping ability and the water absorptivity, and the lint of these samples was small. On the contrary, the hydrophilic nonwoven itself was inferior in the wiping ability and the lint of the nonwoven was much. Further, Samples 14 to 19 had a higher water absorption speed than Comparative Sample C. From this result, it can be said that the water absorption speed can be significantly increased by using the ultrafine fiber layer in combination with the hydrophilic nonwoven.

1. A wiping sheet including a fibrous structure which has an ultrafine fiber layer comprising ultrafine fibers which are obtained from at least two types of ultrafine fiber-generating conjugate fibers and have a fineness of not greater than 0.9 dtex, wherein the ultrafine fibers that are obtained from at least one type of the ultrafine fiber-generating conjugate fiber comprise a modified vinyl alcohol resin, and one or more types of the ultrafine fibers that are obtained from the other ultrafine fiber-generating conjugate fibers comprise another resin(s).

2. The wiping sheet according to claim 1, which comprises at least two types of the ultrafine fibers containing the another resin(s), wherein at least one type of the ultrafine fibers comprising a thermoadhesive resin whose melting point is lower by at least 10° C. than that of any of the other resins which constitute the fibers included in the ultrafine fiber layer and the constituent fibers of the ultrafine fiber layer are thermally bonded by the thermoadhesive resin.

3. The wiping sheet according to claim 1, wherein the fibrous structure is a woven fabric, a knitted fabric, a nonwoven or a combination of thereof.

4. The wiping sheet according to claim 1, wherein the fibrous structure is a nonwoven and the ultrafine fiber-generating conjugate fibers are splittable conjugate fibers comprising a plurality of components and the constituent fibers are entangled by a hydroentangling treatment in the ultrafine fiber layer.

5. The wiping sheet according to claim 4, wherein the ultrafine fibers which are obtained from first splittable conjugate fibers composed of a component containing the modified vinyl alcohol resin and at least one another resin component(s) and second splittable conjugate fibers composed of at least two resin components made of resins other than the modified vinyl alcohol resin.

6. The wiping sheet according to claim 5, wherein the second splittable conjugate fibers are composed of a component containing a thermoadhesive resin whose melting point is lower by at least 10° C. than the melting point of any of the resins constituting the first splittable conjugate fibers, and at least one another resin component(s), and the constituent fibers are thermally bonded by the thermoadhesive resin in the ultrafine fiber layer.

7. The wiping sheet according to claim 5, wherein the ultrafine fiber layer is obtained from a fiber web comprising the first splittable conjugate fibers and the second splittable conjugate fibers at a mass ratio of 8:2 to 3:7 (the first splittable conjugate fibers: the second splittable conjugate fibers).

8. The wiping sheet according to claim 5, wherein the first splittable conjugate fibers have a higher splitting rate than the second splittable conjugate fibers.

9. The wiping sheet according to claim 6, wherein the splitting rate of the second splittable conjugate fibers is in a range of 20% to 80%.

10. The wiping sheet according to claim 5, wherein a vinyl alcohol content of the modified vinyl alcohol resin is in a range of 50% to 70% by mol.

11. The wiping sheet according to claim 5, wherein the component containing the modified vinyl alcohol resin is a component containing an ethylene-vinyl alcohol copolymer resin and at least one of the another resin component(s) is a component containing a polyolefin resin in the first splittable conjugate fibers.

12. The wiping sheet according to claim 6, wherein the component containing the thermoadhesive resin is a component containing a polyethylene resin, and at least one of the another resin component(s) is a component containing at least one resin selected from a polyester resin and a polyolefin resin whose melting points are higher by 10° C. than that of the polyethylene resin in the second splittable conjugate fibers.

13. The wiping sheet according to claim 5, wherein a fineness of the ultrafine fibers obtained from the first splittable conjugate fibers and the second splittable conjugate fibers is not greater than 0.5 dtex.

14. The wiping sheet according to claim 5, wherein the nonwoven is composed of a plurality of the ultrafine fiber layers which are laminated, and at least two of the ultrafine fiber layers are obtained from at least two fiber webs having the mass ratios of the first splittable conjugate fiber to the second splittable conjugate fibers different from each other.

15. The wiping sheet according to claim 14, wherein the nonwoven is composed of the ultrafine fiber layers constituting surfaces and the ultrafine fiber layer constituting inner part,
the fiber layers constituting the surfaces of the nonwoven is obtained from a web comprising the first splittable conjugate fibers and the second splittable conjugate fibers at a mass ratio of 7:3 to 1:9 (the first splittable conjugate fibers: the second splittable conjugate fibers) and the fiber layer constituting the inner part of the nonwoven is obtained from a web comprising the first splittable conjugate fibers and the second splittable conjugate fibers at a mass ratio of 10:0 to 5:5 (the first splittable conjugate fibers: the second splittable conjugate fibers).

16. The wiping sheet according to claim 1, which further comprises a hydrophilic fiber layer comprising hydrophilic fibers,
wherein the ultrafine fiber layers are laminated on both surfaces of the hydrophilic fiber layer, and the constituent fibers of the ultrafine fiber layer are entangled by a hydroentangling treatment, and the hydrophilic fiber layers and the ultrafine fiber layer are integrated by the hydroentangling treatment.

17. The wiping sheet according to claim 16, wherein the hydrophilic fiber layer comprises regenerated cellulose fibers and the regenerated cellulose fibers are self-bonded to give point-bonded areas in the hydrophilic fiber layer.

18. The wiping sheet according to claim 16, wherein the hydrophilic fiber layer comprises regenerated cellulose filaments and has fiber-entangled areas which are formed by entanglement of the regenerated cellulose fibers before the integration with the ultrafine fiber layer.

19. The wiping sheet according to claim 16, wherein the hydrophilic fiber layer comprises hydrophilic filaments and the hydrophilic filaments are at least partially self-bonded in the hydrophilic fiber layer.

20. The wiping sheet according to claim 1, wherein the nonwoven of 100 parts by mass is impregnated with a wetting agent of not greater than 1000 parts by mass.
